(19) United States
(12) Patent Application Publication
(10) Pub. No.: US 2008/0204958 A1
(43) Pub. Date: Aug. 28, 2008

(54) Back-current protection circuit

(75) Inventors: William Shearon, Findlay, OH (US); Mauricio Zavaleta, Basking Ridge, NJ (US)

Correspondence Address: FOGG & POWERS LLC, 10 SOUTH FIFTH STREET, SUITE 1000, MINNEAPOLIS, MN, 55402, US

(73) Assignee: INTERSIL AMERICAS INC., Milpitas, CA (US)

(21) Appl. No.: 12/038,334

(22) Filed: Feb. 27, 2008

Related U.S. Application Data
(60) Provisional application No. 60/891,788, filed on Feb. 27, 2007.

(51) Int. Cl. H02H 9/08

(52) U.S. Cl. 361/93.9

(57) ABSTRACT

A current-limiting switch circuit including a first power semiconductor switch, at least one sense semiconductor switch configured to share a common-gate and a common drain with the first power semiconductor switch, and a second power semiconductor switch serially connected to the first power semiconductor switch and sharing a common node therebetween. The first power semiconductor switch, the first sense semiconductor switch, and the second power semiconductor switch are configured to limit at least a back current.

### CROSS-REFERENCE TO RELATED APPLICATIONS

The present application claims priority to U.S. Provisional Patent Application No. 60/891,788 entitled “A BACK CURRENT LIMITING SWITCH AND RELATED BI-DIRECTIONAL CURRENT LIMIT SWITCHING” filed on filed Feb. 27, 2007 which is incorporated by reference in its entirety into the present application.

### BACKGROUND OF THE INVENTION

Within the past decade personal computers and devices that connect to them have become widespread in use. In the early days of computers, adding a peripheral device to the computer usually involved turning-off the computer power and perhaps opening the computer housing. Once the device was installed, the computer needed to be restarted and it had to run through its initialization, which could be time consuming. This restart and initialization was necessary because connecting a passive device to the computer, more specifically to the computer's power supply bus, often caused a large voltage disturbance to all the components on the power supply bus. Such a disturbance could cause the computer to reset harshly.

The need to rapidly connect and disconnect portable peripherals, like PCM-CIA cards or USB flash-memory drives, drove the development of current controlled switches. These switches gradually increase the load presented to the computer power supply bus and thereby minimize the disturbance to it.

Circuit breaker switches are often integrated or associated with the power circuitry for protecting the switching elements from excessive current, voltage, temperature, etc. There are two conventional methods of over-current sense circuits, (i) voltage detection and (ii) current detection. Voltage detection can be implemented with a sense resistor in series with the power device, or by using the R_{DS}-ON of the power device itself. Current detection can be implemented using a current mirror circuit comprising one or more sense or “pilot” transistors. Other known methods include matched filter, average current, and self-matched filter. The prior art includes devices for sensing forward current through the power driving device.

Significant reverse current levels can be present in certain systems. For example, when a circuit breaker switch drives a highly inductive switched load (e.g., a conventional disk drive) the inductive load implemented (e.g., an H-bridge control switch) can present back-EMF. The high back EMF results in high levels of back-current to the circuit breaker switch. Currently available circuit breaker switches are only operable to prevent or current-limit supply-to-ground current. If the circuit experiences periods of high level back-current, the back-current can disrupt to the upstream supply voltage and possible device damage. For applications that require both forward and reverse current control, such as hard-disk drives, currently available solutions must be implemented using two or more devices, which is generally costly and imprecise.

Because it is critical to reduce switch size and switch resistance as much as possible, it is beneficial to use a modern, small geometry IC process technology. The available technology for low switch resistance and low cost is double-diffused metal-oxide semiconductor (DMOS), which has the fragile gate dielectrics. As such, breakdown limits dictate that the voltage across the gate dielectric (V_{GS}) is likely to be smaller than the supplies that are controlled. DMOS devices generally have parasitic body diode susceptibility, and low V_{GS} (e.g. V) breakdown voltages. Body diode conduction or exceeding the breakdown voltage can result in damage to the DMOS device.

### SUMMARY

One embodiment present invention discloses a current-limiting switch circuit including a first power semiconductor switch, a second power semiconductor switch serially connected to the first power semiconductor switch and sharing a common node therebetween, and at least one sense semiconductor switch. The sense semiconductor switch is configured to share a common-gate and a common drain with to share a common-gate and a common drain with one of the first power semiconductor switch or the second power semiconductor switch. The first power semiconductor switch, the first sense semiconductor switch, and the second power semiconductor switch are configured to limit at least a back current. This summary is not intended to describe all the embodiments of the present application. It is merely provided as an example of an embodiment and does not limit any claimed embodiment in any manner.

### BRIEF DESCRIPTION OF THE DRAWINGS

A fuller understanding of the present invention and the features and benefits thereof will be accomplished upon review of the following detailed description together with the accompanying drawings, in which:

FIGS. 1 and 2 are schematics of exemplary current-limiting switch circuits according to embodiments of the invention.

FIG. 3 shows voltage waveforms during normal operation.

FIG. 4 shows voltage waveforms during normal operation, followed by a reverse conduction phase.

FIG. 5 shows another embodiment of a current-limiting switch circuit according to the invention.

FIGS. 6-8 are schematics of bi-directional current-limiting switch circuits according to embodiments of the present invention.

FIG. 9 is a flow diagram of one embodiment of a method to operate a current-limiting switch circuit in accordance with the present invention.

In accordance with common practice, the various described features are not drawn to scale but are drawn to emphasize features relevant to the present invention. Reference characters denote like elements throughout figures and text.

### DETAILED DESCRIPTION

A circuit breaker switch to protect against both excessive forward and excessive back-current, that also includes an arrangement for protecting against body diode conduction and excessive V_{GS} applied in the of DMOS devices is desirable. Embodiments of the circuitry described herein block reverse current without the forward loss of a diode drop. Such circuits are specially designed for use with small gate to source voltages so that modern integrated circuit breakdown voltages are not exceeded. In such embodiments, a floating/tracking power rail bounds the gate-to-source drive voltage (V_{GS}). A lower level rail for the gate driver may be higher or lower voltage than the blocking output voltage. In some implementations of the current-limiting switch circuit the power semiconductor switches and the sense semiconductor switches are field effect transistors. An exemplary current-limiting switch circuit comprises a first integrated power switching field effect transistor (FET) device and at least a second integrated power switching FET device serially connected and sharing a common node (V_{MID}) there between. The first “pass” FET device and second “block” FET device are disposed between an input supply voltage contact and an output node (V_{OUT}) which drives a load. In one implementation of this embodiment, the FETs described herein are replaced by other transistors.

Other embodiments of the circuitry described herein allow a silicon switch to either emulate a fuse for forward or reverse currents or to behave as a current limiter in forward or reverse direction. Thus, devices attached to power supplies incorporating such a circuit are prevented from sourcing or sinking excessive current. In such embodiments, current monitoring devices, such as pilot sense-FET devices, are arranged in two directions to monitor the current flow in both directions. An exemplary bi-directional current-limiting switch circuit includes at least two series FETs switched connecting an input “supply” voltage to an output load, which may include a supply or stored energy source to deliver current or voltage like a supply. A current monitoring device, such as a sense-FET can be connected in parallel with the high power FET device, so that two of the three FET main terminals are common-connected. A current sink, a current source, or a current sink and source are connected to the sense-FET's third main terminal, either drain or source. A comparator monitors the voltage between the power FET and sense FETs non-common terminal. In one implementation of this embodiment, there are two sense-FETs, one for each current direction (possibly in the power FET). In another implementation of this embodiment, there is a single sense-FET with a switching source to sink current for the reference current. In yet another implementation of this embodiment, the sense-FETs are replaced with a small sense resistor in series. In yet another implementation of this embodiment, the sense-FETs are replaced with a power FET R_{DS}-ON resistance.

A reverse current detection circuit senses reverse current flowing through the first or second power FET, wherein an output of the reverse detection circuit is coupled to a gate of the block FET, wherein responsive to back-current above a predetermined level the reverse detection circuit turns off the block FET and turns on the block FET when the back-current level falls to a safe lower level.

Although the present invention will be described using metal-oxide semiconductor (MOS) power switches, specifically double-diffused metal-oxide semiconductor (DMOS) switches, which are non-symmetric MOS devices having drains herein shown in figures provided with a widened/darkened representation, the invention can be implemented with more conventional MOS transistors (either positive-channel metal-oxide semiconductor (PMOS) and/or negative-channel metal-oxide semiconductor (NMOS)) and/or bipolar transistors.

In one arrangement, using DMOS FETs, the pass and block FETs have opposing source-drain directions, such as connected sources. If the two power FETs have connected sources, then a generated tracking supply or sliding clamp (which is not referenced to ground) is provided, referenced to this common source node (or a voltage that leads, follows or otherwise tracks this node) that bounds at least the block-function power FETs switch's V_{GS} ON voltage, including during at least part of the startup ramp.

In another arrangement, the two power DMOS FETs have connected drains and the supply or clamp that drives the block-function power FET gate must be clamped to within a safe voltage (below V_{GS} breakdown voltage) of the block-function power FET source. In this case, the supply voltage will not necessarily vary during startup ramp.

In one embodiment, the current-limiting switch circuit can operate an integrated blocking switch digitally. The reverse current detection to begin current blocking (switch-off) can be done in one of several ways, but the detector to end current blocking (switch-on) will monitor V_{OUT} to do so. This circuit operates like a reverse-current circuit-breaker, in one embodiment being resettable, but possible to be arranged non-resettable.

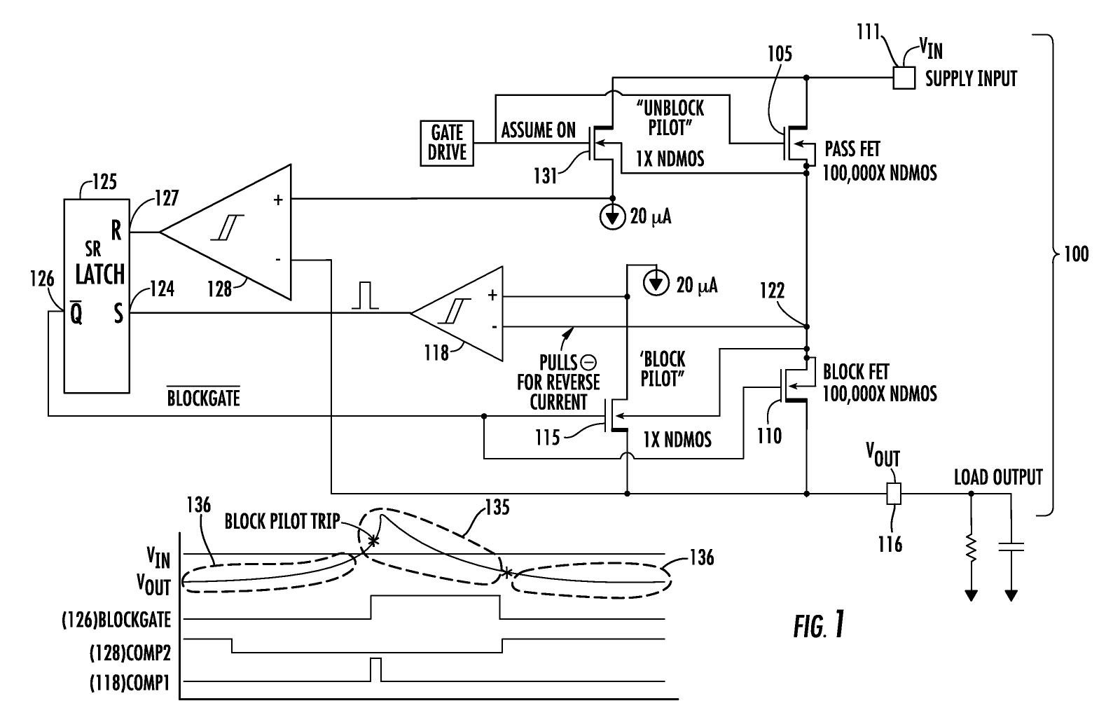

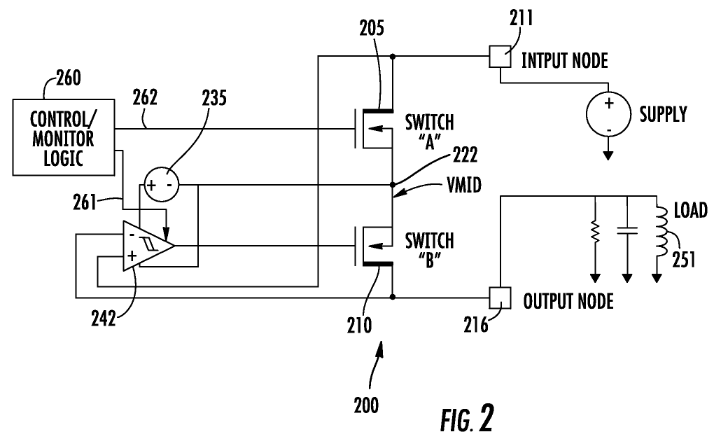

FIGS. 1 and 2 are schematics of exemplary current-limiting switch circuits according to embodiments of the invention. FIG. 1 is a schematic of an exemplary current-limiting switch circuit 100 providing reverse current sensing and blocking implemented in a latch-off and reset-on mode, according to an embodiment of the invention. The current-limiting switch circuit 100 is also referred to herein as a “back-current control circuit 100” and “back-current protection circuit 100.” As shown in FIG. 1, the a back-current control circuit 100 includes a first power FET 105, a first sense FET 131, a second power FET 110, a second sense FET 115, comparators 118 and 128, and an SR latch 125. As used herein, the term “first power FET 105” is interchangeable with the term “pass FET 105, the term “first sense FET 131” is interchangeable with the term “unblock pilot 131,” the term “second power FET 110” is interchangeable with the term “the term “block FET,” and the term “second sense FET 115” is interchangeable with the term “block pilot 115.”

The first power FET 105 and the second power FET 110 are serially connected and share a common node 122 at a voltage V_{MID} therebetween. In the arrangement shown in FIG. 1, the pass FET 105 and block FET 110 have opposing source-drain directions. The current-limiting switch circuit 100 provides reverse current sensing and blocking implemented in a digital embodiment to switch between a latch-off mode and a reset-on mode.

Also provided in FIG. 1 are sample waveforms showing a cycle including latch-off mode represented generally at 135 (V_{OUT}>V_{IN}) and reset-on mode represented generally at 136 (V_{OUT}<V_{IN}). As known in the art, the triggering levels can be set by the values of the current sources/sinks associated with block pilot 115 and unblock pilot 131 shown in FIG. 1. More specifically, the current source/sink level can be selected to produce a voltage drop across the sense FET which equals the voltage drop across the mirror connected power FET being monitored when the current through the power FET being monitored equals the level at which current limiting is desired to occur. For example, the current source/sink level is selected to produce a voltage drop across the first sense FET 131 to set the hysteresis voltage to which the output must fall before disabling the BLOCKGATE signal. Alternatively, this hysteresis voltage can be reduced by connecting the comparator 128 noninverting input directly to the VIN supply 111.

In one implementation of this embodiment, the first and second power FETs 105 and 110 are integrated power switching negative-channel double-diffused metal-oxide semiconductor (NDMOS) devices. In another implementation of this embodiment, the first power FET 105 and second power FET 110 are other semiconductor switches. In yet another implementation of this embodiment, the first sense FET 131, and the second sense FET 115 are other semiconductor switches.

The pass FET 105 and block FET 110, shown in the exemplary embodiment of FIG. 1 as 100,000× devices, are disposed between an input node 111 (at a voltage V_{IN}) and an output node 116 (at a voltage V_{OUT}), which drives a load. The input node 111 can be a supply voltage contact. The load itself may contain a supply or stored energy, such as inductor, which may deliver current or voltage, like a power supply. A reverse current detection comprising block pilot 115 shown as a small 1×NDMOS senses reverse current flowing through block FET 110. An output of block pilot 115 is coupled to the non-inverting input of comparator 118 while V_{MID} is coupled to the inverting input of comparator 118. The output of comparator 118 is coupled to the set input 124 of SR latch 125. The Q complement output 126 of latch 125, appropriately voltage scaled, is coupled to the gates of block pilot 115 and the gate of block FET 110. As shown by the waveforms below current-limiting switch circuit 100 in FIG. 1, upon the sensing of sufficient back-current, block pilot 115 causes the output of comparator 118 to go high. This sets SR latch 125 and causes Q complement to go low (shown as block gate complement going high), thus turning off block FET 110 (and block pilot 115).

As shown in FIG. 1, the unblock pilot 131 is a 1×DMOS FET. The source of unblock pilot 131 is coupled to the non-inverting input of comparator 128 while output node 116 is coupled to the inverting input of comparator 128. The output of comparator 128 is coupled to the reset input 127 of SR latch 125. As output node 116 returns to a level so that V_{IN}>V_{OUT}, the output of comparator 128 goes high so that a reset signal is provided to SR latch 125, which cause Q complement to go high (shown as block gate complement going low). This turns on block FET 110 (and block pilot 115).

Since first power FET 105 and the second power FET 110 have connected sources, a generated tracking supply or sliding clamp (or a voltage that leads, follows or otherwise tracks this node) referenced to the common node 122 for the sources can be provided. The tracking supply or sliding clamp is not referenced to ground. The tracking supply or sliding clamp bounds at least the block power FET's V_{GS} ON voltage during at least part of the startup ramp to V_{MID}. However, if the current-limiting switch circuit 100 is implemented with a dielectric isolation technology or with MOS power switches that have a high enough gate oxide breakdown voltage, a generated tracking supply or sliding clamp is not needed.

FIG. 2 is a schematic of a current-limiting switch circuit 200 according to another embodiment of the present invention. The current-limiting switch circuit 200 includes a first power FET 205, at least one second power FET 210, a comparator 242, control/monitor logic 260, and a floating power supply 235. The first power FET 205 (also referred to as “switch A”) has a drain connected to an input node 211 (at a voltage V_{IN}) of the current-limiting switch circuit. The second power FET 210 (also referred to as “switch B”) has a drain connected to an output node 216 (at a voltage V_{OUT}) of the current-limiting switch circuit 200. The first power FET 205 and the second power FET 210 are serially connected between the input node 211 and the output node 216 of the current-limiting switch circuit 200. The comparator 242 is configured to drive the gate of the second power FET 210. The control/monitor logic 260 is coupled to the comparator 242 and is configured to drive the first power FET 205. The floating power supply 235 is connected to the comparator 242 to limit the gate to source drive voltage of the second power FET 210. In one implementation of this embodiment, the first power FET 205 and the second power FET 210 are double-diffused metal-oxide semiconductor devices.

The output node 216 drives a load. The load itself may contain a supply or stored energy, such as inductor 251, which may deliver current or voltage, like a power supply. A typical design requirement is to prevent the first power FET and the second power FET 210 from conducting current through the body of the diode.

Current-limiting switch circuit 200 includes features particularly advantageous for DMOS devices, designed to avoid turning on the parasitic pnp bipolar devices associated with either of the power DMOS FETs (such as first power FET 205 and/or second power FET 210) resulting from forward bias of their associated body diodes. DMOS FETs have lightly-dope-drains which permit high voltage on the drain relative to the other device voltages. Current-limiting switch circuit 200 also includes features to limit generally limit gate to source voltage (V_{GS}) to a voltage less than the DMOS breakdown voltage, such as less than about 5 volts.

Second power FET 210 has its drain at the typically lower voltage output (V_{OUT}) side. Since the parasitic p-body to n-drain diode on second power FET 210 is at risk of being forward biased, care must be given to prevent second power FET 210 from being OFF when first power FET 205 is ON and the output is sinking current (forward/normal conduction). This is accomplished by current-limiting switch circuit 200 having a floating supply 235 (also referred to herein as a charge pump), which provides a floating supply level above the common node 222 voltage V_{MID}, and by sequencing second power FET 210 ON first and OFF last with respect to first power FET 205. The floating/tracking power supply 235 is connected to the comparator 242. This connection bounds the second power FET's 210 source drive voltage V_{GS} to that of the floating supply 235. During back-current operation (reverse conduction, V_{OUT} and V_{MID}>V_{IN}), the comparator 242 detects output voltage rise above V_{IN} and shuts off second power FET 210 while leaving first power FET 205 ON. When the output discharges below V_{IN}, second power FET 210 is re-enabled. As used herein the terms “floating/tracking power supply,” “tracking power supply,” and “floating power supply” are interchangeable.

The comparator 242 includes output enable circuitry. The control/monitor logic 260 has a first output 261 coupled to enable circuitry of the comparator 242 and a second output 262 coupled to the gate of first power FET 205. The term control/monitor logic as used herein refers to logic for controlling and/or monitoring the circuitry in the embodiments of current-limiting switch circuits described herein. Although the inverting input of comparator 242 is shown coupled to V_{OUT}, that input of comparator 242 can also be coupled to V_{MID} if blocking is to latch.

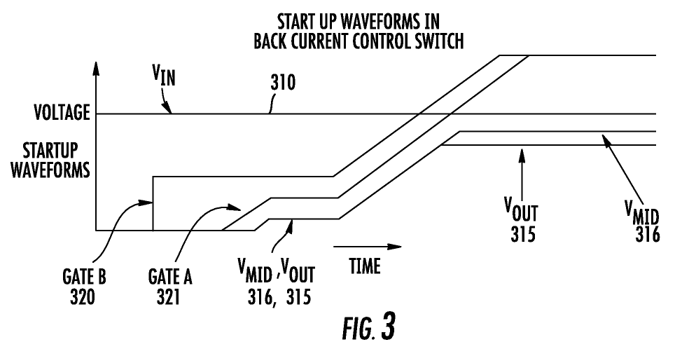

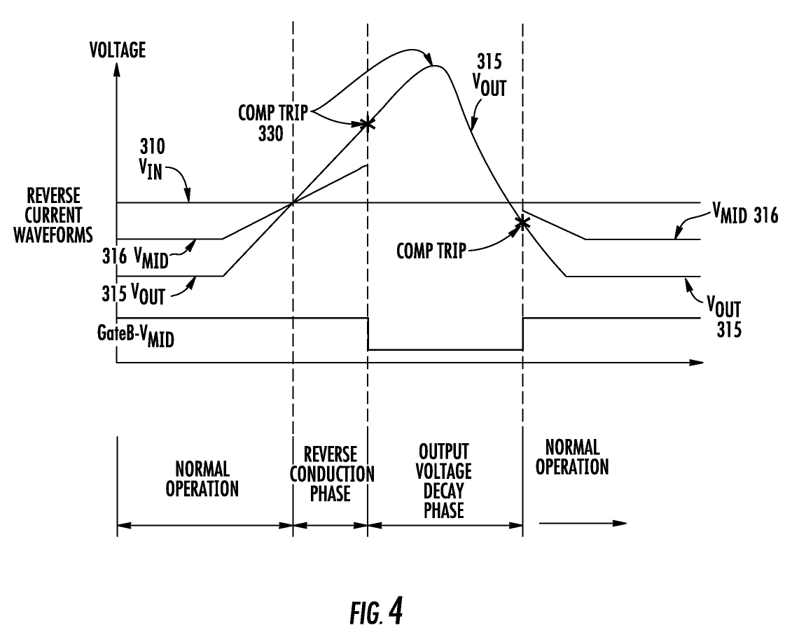

FIGS. 3 and 4 show exemplary voltage versus time start-up waveforms at various nodes for a switching circuit according to the invention. FIGS. 3 and 4 are described with reference to the current-limiting switch circuit 200 of FIG. 2. FIG. 3 shows voltage waveforms during normal operation. Normal operation is also referred to herein as “forward conduction,” when output voltage V_{OUT} represented generally by numeral 315 and V_{MID} represented generally by numeral 316 are less than V_{IN} represented generally by numeral 310. The voltage waveforms for the second power FET 210 (gate B represented generally by numeral 320) is ON before voltage waveforms for the first power FET 205 (gate A represented generally by numeral 321) is ON. As described above, if second power FET 210 is always ON when first power FET 205 is ON, the parasitic drain to the body diode of second power FET 210 is not forward biased.

FIG. 4 shows voltage waveforms during normal operation, followed by a reverse conduction phase. During the reverse conduction phase, the output voltage 315 (V_{OUT}) and the common node voltage 316 (V_{MID}) are greater than the input voltage 310 (V_{IN}). The reverse conduction phase is followed by an output voltage decay phase. The output voltage decay phase is started and stopped by the comparators 118 and 128 (FIG. 1) turning off the second power FET 110 (FIG. 1) at the times indicated at 330. During the output voltage decay phase, the output voltage 315 (V_{OUT}) gradually drops. The waveform for first power FET 205 (switch A) is not shown in FIG. 4 as it is not involved in reverse current blocking. When the output voltage 315 (V_{OUT}) discharges to the level below the input voltage 310 (V_{IN}), second power FET 210 is enabled again and the circuit returns to normal operation.

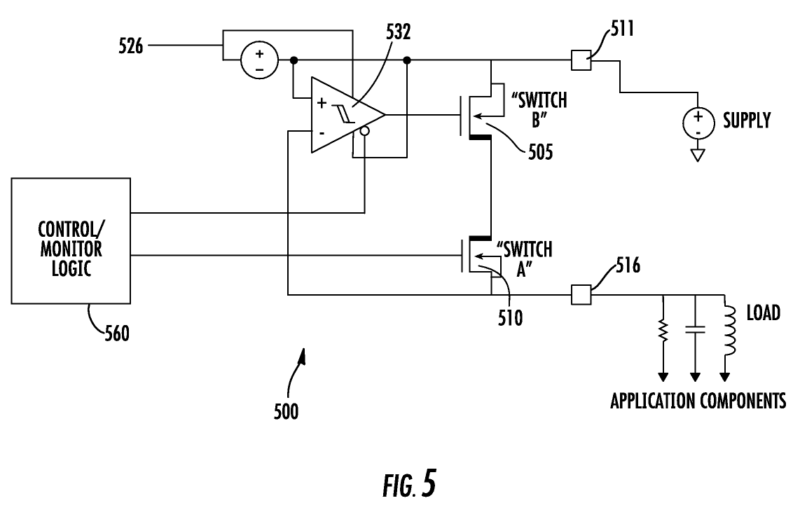

FIG. 5 shows a non-preferred, embodiment of a current-limiting switch circuit 500 according to the invention. In this embodiment, the relative position of switch A and switch B in FIG. 5 is reversed from the relative position of switch A and switch B in FIG. 1. As shown in FIG. 5, the source of switch B (power FET 505) is connected to input node 511 (at a voltage V_{IN}) and the source of switch A (power FET 510) is connected to output node 516 (at a voltage V_{OUT}). The descriptive terms “first” and “second” are not used with reference to the power FETs in the discussion relating to FIG. 5 in order to avoid confusion due to the switched positions of the two power FETs relative to FIG. 2.

A floating/tracking power supply 526 drives switch B (FET switch 505), which is coupled to the output of the comparator 532. In this embodiment, the FET switch 505 functions as the blocking FET. The FET switch 510 may have a different floating/tracking power supply.

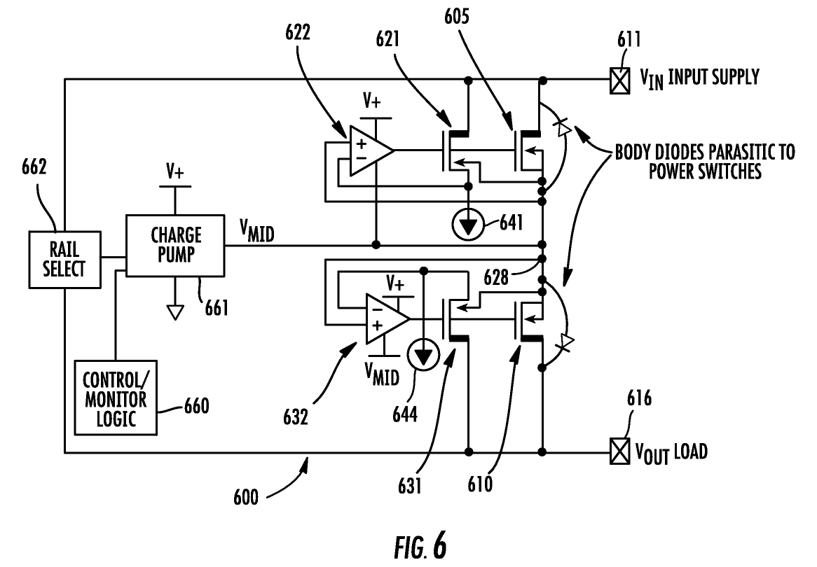

In other embodiments, bi-directional current limiting switch circuits are used. Some embodiments of bi-directional current-limiting switch circuits operable to detect forward and reverse current are now described generally and then specifically with reference to FIGS. 6-8. FIGS. 6-8 are schematics of bi-directional current-limiting switch circuits according to embodiments of the present invention. The bidirectional current-limiting switch circuits include two power FET switches for controlling the current. Because it is critical to reduce switch size and resistance as much as possible, it is beneficial to use a modern, small geometry IC process technology. As described above, small geometry devices have the most fragile gate dielectric. As such, breakdown limits dictate that the voltage across the gate dielectric (V_{GS}) is likely to be smaller than the supplies that are controlled. This presents a design obstacle which is circumvented in the bidirectional current-limiting switch circuit described herein. The bidirectional current-limiting switch circuit includes an internally generated supply that tracks the power FET sources as described above relative to related current-limiting switch circuits.

The embodiments of the bi-directional current-limiting switch circuits described herein comprise a first integrated power FET device and at least a second integrated power FET device serially connected and sharing a common node (V_{MID}) therebetween. The first integrated power FET device and at least a second integrated power FET device are disposed between an input supply voltage contact and an output node which drives a load. A first current detection circuit monitors a source (forward) current flowing through the first or the second power FET. A second current detection circuit monitors the sink (reverse) current flowing through the first or the second power FET. A first control circuit (also referred to herein as a first comparator) has an input coupled to the first current detection circuit and an output coupled to a gate of the first power FET. A second control circuit (also referred to herein as a second comparator) has an input coupled to the first current detection circuit and an output coupled to a gate of the second power FET. The control circuits operate collectively to limit current, latching-off current or latching-off excessive current for respective forward current, and limiting current, latching-off current or latching-off excessive current for the reverse current. Forward current control need not be the same as back-current control. For example, the forward current can be current limited while the reverse (back) current can be latched-off when triggered, as described above with reference to the SR latch arrangement of FIG. 1.

In one embodiment, the first and second power FET switches are DMOS switches connected in series with opposing source-drain direction, such as source to source. The forward current detection circuit drives the gate of the pass-function power FET in linear fashion to limit forward current or power, while the reverse current detection circuit drives the gate of the block-function power FET in linear fashion to limit reverse current or power. Circuitry in one embodiment is provided to ensure at most only one limiter is actively limiting at a time, and the other comparator is in compliance, driving its gate so that it is fully ON. Any limiter comparator in compliance with gate fully ON must bound the gate voltage to within a safe V_{GS} gate oxide breakdown limit, such as <5 V.

If the two power FETs are two DMOS devices having connected sources, then a generated tracking supply or sliding clamp (not referenced to ground) is generally provided. Such a tracking supply or sliding clamp is referenced to the common source node (or a voltage that leads, follows or otherwise tracks this node). This configuration bounds the block-function power FETs switch's V_{GS} ON voltage at least during part of the startup ramp.

If the drains of the two power FET are connected together, two generated tracking supplies or sliding clamps (i.e., not referenced to ground) are generally provided. Such tracking supplies or sliding clamps are referenced to each power FET's source (or a voltage that leads, follows or otherwise tracks the power FET sources). This configuration separately bounds the ON voltage for each of the power FETs' switch's V_{GS}.

Bidirectional current-limiting switch circuits according to some embodiments of the present invention operate in both directions, like a fuse, but change the channel resistance of one of the two power FETs when current or power would otherwise exceed a preset limit. The forward and reverse current limits may be different. These bi-directional embodiments allow an integrated circuit-based switch, such as a silicon-based switch, to either emulate a fuse for forward and/or reverse currents or to behave as a current limiter in both the forward and reverse directions. Therefore, a bi-directional current-limiting switch circuit attached to a computer power supply can be prevented from either sourcing or sinking excessive current. This is advantageous for applications in which a circuit breaker switch drives a highly inductive, switched load. In such applications, an implementation of the bi-directional current-limiting switch circuit prevents high levels of back-current from passing through the circuit breaker switch. Some embodiments employ at least two pilot devices. Other available current sensing methods may be used, including, but not limited to a sense resistor(s) or R_{DS}-ON sensor(s).

FIG. 6 is a schematic of a bi-directional current-limiting switch circuit 600 according to an embodiment of the present invention. As shown in FIG. 6, the bi-directional current-limiting switch circuit 600 includes a first power FET 605, a first sense FET 621, a second power FET 610, a second sense FET 631, a first amplifier 622, a second amplifier 632, control/monitor logic 660, a power rail selector 662, and a charge pump 661 (or floating supply). The second power FET 610 is serially connected to the first power FET 605 and shares a common source node (V_{MID}) with the first power FET 605. The first and second sense FETs 621 and 631 are also referred to herein as pilot FETs. In one implementation of this embodiment, the first and second power FETs 605 and 610 are negative-channel double-diffusion metal-oxide-semiconductor (NDMOS) FETs. In another implementation of this embodiment, the first and second power FETs 605 and 610 and the first and second power FETs 605 and 610 are other semiconductor switches.

The first sense FET 621 shares a common-gate and a common drain with the first power FET 605. The first power FET 605 and the first sense FET 621 limit a forward current in the current-limiting switch circuit 600 between the input node 611 that is connected to a V_{IN} supply and the output node 616 that drives a load V_{OUT}. The second sense FET 631 shares a common-gate and a common drain with the second power FET 610. The second power FET 610 and the second sense FET 631 limit a back current in the current-limiting switch circuit 600 from the output node 616 to the input node 611. Specifically, the gate of the first power FET 605 is driven lower when the source current through first power FET 605 exceeds the current density of the related sense FET 621. As used herein, the term “source current” is interchangeable with the term “forward current.”

An input of the first amplifier 622 is connected to the common node 628 (at voltage V_{MID}) so that the output of the first amplifier 622 is bounded to V_{MID}. The first amplifier 622 drives the gates of the first power FET 605 and the first sense FET 621. An input of the second amplifier 632 is also connected to the common node 628 so that the output of the second amplifier 632 is bounded to V_{MID}. The second amplifier 632 drives the gates of the second power FET 610 and the second sense FET 631.

The control/monitor logic 660 sequences the first amplifier 622 and the second amplifier 632 to turn on the second power FET 610 and first power FET 605 so that the first power FET 605 is ON after the second power FET 610 is ON, and so that the first power FET 605 is OFF before the second power FET 610 is OFF.

The output node 616 drives a load V_{OUT}. The load itself may contain a supply or stored energy which may deliver current or voltage, like a power supply. In this embodiment, the FET configuration allows both gates to remain at ground the instant after the power is applied, since V_{MID} is at ground the instant before and after the power is applied. In this manner, the breakdown voltage V_{GS} is not exceeded. In one implementation of this embodiment, the breakdown voltage V_{GS} is about 5 Volts.

The predetermined source current level is set by current source 641. Because the ON resistance of first sense FET 621 is proportional to and tracks the ON resistance of the first power FET 605, the current source 641 associated with the first sense FET 621 is set up to provide a reference voltage across the first sense FET 621 against which the voltage drop across the first power FET 605 is amplified. More specifically, the current source 641 is selected to produce a voltage drop across the first sense FET 621 that equals the voltage drop across the first power FET 605 being monitored when the current through the first power FET 605 equals the level at which current limiting is desired to occur.

The second sense FET 631 monitors source current flowing through the second power FET 610. The amplifier 632 drives down the gate of the second power FET 610 when the source current through second power FET 610 exceeds a predetermined source current level multiple that is set by the level of current source 644.

Thus, in FIG. 6, monitoring devices embodied as the first and second sense-FETs 621 and 631 are connected in parallel in a current mirror arrangement with both the first and second power FET devices 605 and 610. In this manner, two of the three main terminals (i.e., gate/drain) in the first (second) sense FET 621 (631) and first (second) power FETs 605 (610) are common-connected. A current source is connected to the first (second) sense-FET's 621 (631) third (non-common) main terminal, the source. The amplifier 622 (632) monitors the voltage between the first (second) power FET's 605 (610) and first (second) sense FET's 621 (631) non-common terminal.

The bi-directional current-limiting switch circuit 600 has symmetry of design and layout, low-side supply for both current sources 641 and 644, which advantageously reduces noise and simplifies trimming, while neither of the first and second sense FETs 621 and 631 experiences source-body-diode forward biased during saturation.

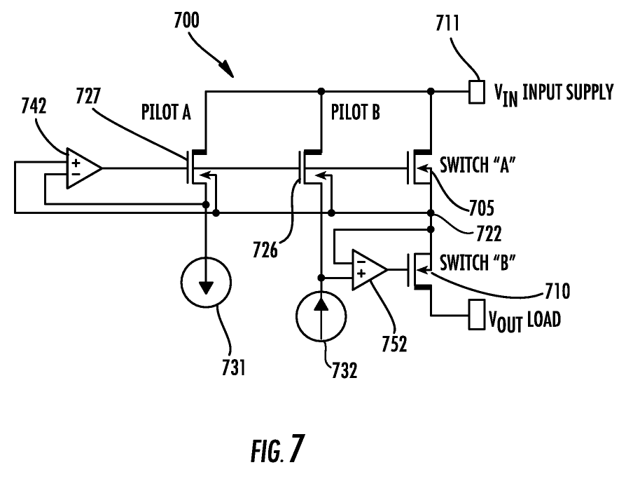

FIG. 7 is a schematic of a bi-directional current-limiting switch circuit 700 according to a second embodiment of the present invention. The bi-directional current-limiting switch circuit 700 differs from the bi-directional current-limiting switch circuit 600 described above with reference to FIG. 6, in that an additional sense FET 726 is positioned between the first power FET 605 and the first sense FET 621 and the second sense FET 631 is removed from the circuit.

As shown in FIG. 7, a first sense FET 727 and a second sense FET 726 share a common gate and a common drain with each other and with the first power FET 705. A first amplifier 742 has an input connected to the common node 722 (at a voltage V_{MID}) and another input connected to the source of the second sense FET 727. A first current source 731 is connected to the source of the first sense FET 727 and to the input of the first amplifier 742. The first amplifier 742 drives the gates of the first power FET 705, the first sense FET 727, and the second sense FET 727.

The second amplifier 752 has an input connected to the common node 722 and another input connected to the source of the second sense FET 726. A second current source 732 is connected to a source of the second sense FET 726 and to an input of a second amplifier 752. The second amplifier 752 drives the gate of the second power FET 710. In this configuration, the first amplifier 742 of the bi-directional current-limiting switch circuit 700 regulates the first power FET 705 when the sink current exceeds a predetermined current level and the second amplifier 752 regulates the second power FET 710 when a reverse source current exceeds the predetermined current level.

The bi-directional current-limiting switch circuit 700 also includes a control/monitor logic (not shown in FIG. 7) that sequences the first amplifier 742 and the second amplifier 752, so that the second power FET 710 is ON before the first power FET 705 is ON, and the first power FET 705 is OFF before the second power FET 710 is OFF.

The output of the first amplifier 742 is connected to the gate of first power FET 705 to make equal the voltage between the non-common node (source) of first power FET 705 and the non-common node (source) of the scaled down sense FET 727 and to thereby limit the current. First amplifier 742 regulates down the first power FET 705 when the sink current would exceed a predetermined current level. The output of the second amplifier 752 is connected to the gate of FET 710 to make equal the voltage between the non-common node (source) of first power FET 705 and the non-common node (source) of sense FET 726 and to regulate the second power FET 710 when the reverse source current, generally coming from a load, exceeds a predetermined current level. In one implementation of this embodiment, the first power FET device 705 and the second power FET device 710 are double-diffused metal-oxide semiconductor devices. In this embodiment, the pilot devices, sense FET 726 and sense FET 727, can be co-located so that they are better matched and trimming is reduced.

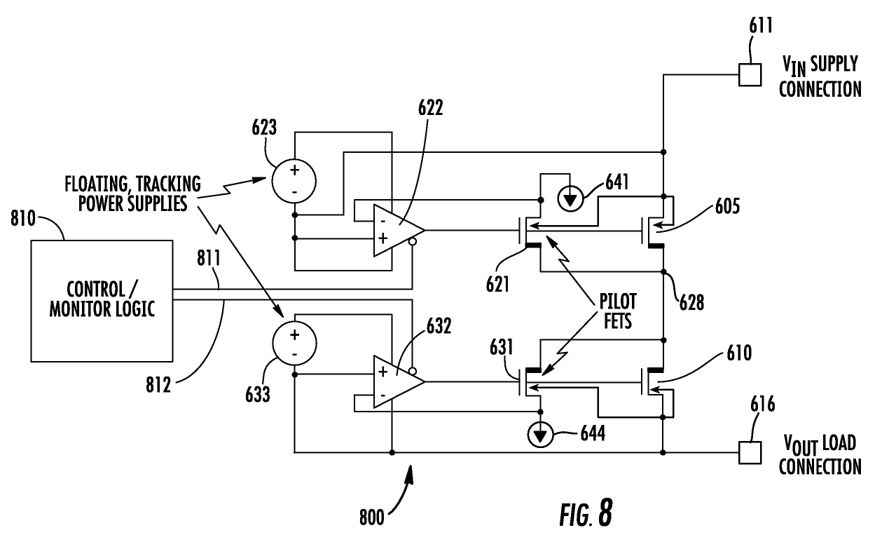

FIG. 8 shows a schematic of a bi-directional current-limiting switch circuit 800 according to an embodiment of the present invention. Bi-directional current-limiting switch circuit 800 is a modification of the bi-directional current-limiting switch circuit 600 shown in FIG. 6, with common features identified as before. The bi-directional current-limiting switch circuit 800 shown includes features particularly advantageous for power DMOS devices, such as control/monitor logic and floating/tracking power supplies. Specifically, bi-directional current-limiting switch circuit 800 includes features particularly advantageous for power DMOS devices, designed to avoid turning on the parasitic pnp bipolar devices associated with either of the power DMOS FETs resulting from forward bias of their associated body diodes.

DMOS FETs have lightly-dope-drains that permit high voltage on the drain relative to the other device terminals. Second power FET 610 has its source at the typically lower voltage output (V_{OUT}) side. Since the parasitic body to drain diode of first power FET 605 is at risk of being forward biased, care must be given to prevent second power FET 610 from being turned on when first power FET 605 is OFF and the output is sinking current. The bi-directional current-limiting switch circuit 800 sequences the first power FET 605 ON first and OFF last with respect to second power FET 610.

The bi-directional current-limiting switch circuit 800 includes a first floating power supply 623 and a second floating power supply 633 that provide floating supply levels above the voltage V_{IN} at the input node 611 and above the voltage V_{OUT} at the output node 616, respectively. The first floating power supply 623 provides power and maximum output compliance voltage for the first amplifier 622. Thus, the floating/tracking power supply 623 bounds the gate to source drive voltage V_{GS} of the gates of the first sense FET 621 and the first power FET 605 driven by the output of the first amplifier 622. The second floating supply 633 provides power and maximum output compliance voltage for the second amplifier 632. Thus, the floating/tracking power supply 633 bounds the gate to source drive voltage V_{GS} of the gates of the second sense FET 631 and the second power FET 610 driven by the output of the second amplifier 632.

The first amplifier 622 and second amplifier 632 include output enable (forcing) circuitry. The output forcing allows controlled sequencing of the power FETs during start up and shut down, when the sense FET control must be superseded. This function is performed by control/monitor logic 810, having a first output coupled to enable circuitry of the first amplifier 622 and a second output 812 coupled to the enable circuitry of the second amplifier 632.

The first floating supply 623 and second floating supply 633 may utilize charge pumps. Floating supplies 623 and 633 ensure the high supply voltage provided to the amplifiers are floating voltage that sets the V_{CC} voltage a fixed voltage above the voltage provided at the noninverting inputs of the respective amplifiers to avoid exceeding V_{GS} breakdown limits. In the back-current case, the first amplifier 622 detects output voltage rise above input and shuts off/regulates down first power FET 605 while leaving second power FET 610 ON. When the output finally discharges below the input voltage again, the first power FET 605 could be re-enabled by the control/monitor logic 810. Specifically, the control/monitor logic 810 sequences the first amplifier 622 and the second amplifier 632 to sequence turning ON the first power FET 605 and second power FET 610 so that the first power FET 605 is turned ON before turning ON the second power FET 610, and awaits the second power FET 610 to turn OFF before turning OFF the first power FET 605.

Although the sense-FET approach described above provides inherent thermal matching, the invention can in another embodiment replace the sense FETS with either a small series sense resistor, or using the power FET R_{DS}-on resistance as a sense resistor, or other methods for current sensing known in the art.

As noted above, the invention is expected to be particularly advantageous for power circuits driving highly inductive, switched loads, such as presented by a conventional disk drive, where there is a possibility that the inductive load implemented, such as when an H-bridge control switch is used, which can present back-EMF and resulting high levels of back-current to the circuit breaker switch. For example, for the computer peripheral market, especially peripherals containing motors. As described above, bi-directional current-limiting switch circuits described in this document provide protection for both forward and reverse (back) currents. Although described as a stand-alone bi-directional switch, the present invention can be integrated with a power regulator by modifying the power switching stage to include features of the bidirectional power switch as described above.

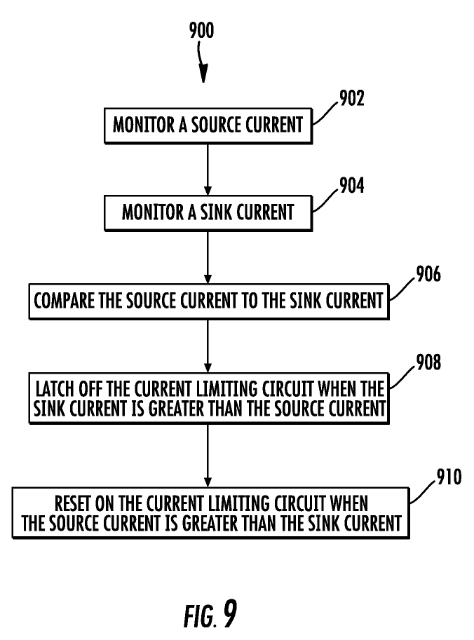

FIG. 9 is a flow diagram of one embodiment of a method 900 to operate a current-limiting switch circuit in accordance with the present invention. This method is applicable to the current-limiting switch circuits 100, 200, 500, 600, and 700 as described above with reference to FIGS. 1, 2, 5, 6 and 7, respectively. At block 902, a source current is monitored. At block 904, a sink current is monitored. At block 906, the source current is compared to the sink current.

At block 908, the current-limiting switch circuit is turned off when the source current is greater than the sink current. In one implementation of this embodiment, the current-limiting switch circuit is latched OFF when the sink current is greater than the source current. In the exemplary embodiment shown in FIG. 1, the sensing of sufficient back-current at block pilot 115 causes the output of comparator 118 to go high. This sets SR latch 125 and causes Q complement to go low, turning off block FET 110 and block pilot 115. In the exemplary embodiment shown in FIG. 6, the control/monitor logic 660 sequences the first amplifier 622 and the second amplifier 632 so that the first power FET 605 is OFF before the second power FET 610 is OFF. In the exemplary embodiment shown in FIG. 8, the control/monitor logic 810 sequences the first amplifier 622 and the second amplifier 632 so that the second power FET 610 is OFF before the first power FET 605 is OFF.

At block 910, the current-limiting switch circuit is tuned ON when the source current is greater than the sink current. In one implementation of this embodiment, the current-limiting switch circuit is reset ON when the source current is greater than the sink current. In the exemplary embodiment shown in FIG. 1, when the output node 116 returns to a level so that V_{IN}>V_{OUT}, the output of comparator 128 goes high so that a reset signal is provided to SR latch 125, which causes Q complement to go high. This turns on block FET 110 and block pilot 115. In the exemplary embodiment shown in FIG. 6, the control/monitor logic 660 sequences the first amplifier 622 and the second amplifier 632 so that the second power FET 610 is ON before first power FET 605 is ON. In the exemplary embodiment of FIG. 8, the control/monitor logic 810 sequences the first amplifier 622 and the second amplifier 632 so that the first power FET 605 is ON before second power FET 610 is ON.

The circuits described herein have been shown and described in relation to an NFET high side driver/limiter; however, the invention is also applicable to a PFET low-side driver/limiter which would be complementary to the one shown. Of course, there are other equivalent ways to provide the switching between the pilots.

It is to be understood that while the invention has been described in conjunction with the preferred specific embodiments thereof, that the foregoing description as well as the examples which follow are intended to illustrate and not limit the scope of the invention. Other aspects, advantages and modifications within the scope of the invention will be apparent to those skilled in the art to which the invention pertains.

We claim:

1. A current-limiting switch circuit, comprising:
a first power semiconductor switch;
a second power semiconductor switch serially connected to the first power semiconductor switch and sharing a common node there between;
at least one sense semiconductor switch configured to share a common-gate and a common drain with one of the first power semiconductor switch and the second power semiconductor switch; and
wherein the first power semiconductor switch, the sense semiconductor switch, and the second power semiconductor switch are configured to limit at least a back current.

2. The current-limiting switch circuit of claim 1, wherein the at least one sense semiconductor switch comprises:
a first sense semiconductor switch configured to share a common-gate with the first power semiconductor switch; and
a second sense semiconductor switch configured to share a common-gate and a common drain with the second power semiconductor switch.

3. The current-limiting switch circuit of claim 2, wherein the first and second power semiconductor switches and the first and second sense semiconductor switches are field effect transistors.

4. The current-limiting switch circuit of claim 3, wherein the first power field effect transistor and the second power field effect transistor are double-diffused metal-oxide semiconductor devices.

5. The current-limiting switch circuit of claim 2, further comprising:
a first amplifier having an input connected to the common node, the first amplifier configured to drive the gates of the first power semiconductor switch and the first sense semiconductor switch; and
a second amplifier having an input connected to the common node, the second amplifier configured to drive the gates of the second power semiconductor switch and the second sense semiconductor switch, wherein the first power semiconductor switch, the first sense semiconductor switch, the second power semiconductor switch, and the second source semiconductor switch, the first amplifier, and the second amplifier are configured to limit a back current and a forward current.

6. The current-limiting switch circuit of claim 5, further comprising:
a control/monitor logic configured to sequence the first amplifier and the second amplifier, wherein the first power semiconductor switch is turned on before the second power semiconductor switch is turned on, and the second power semiconductor switch is turned off before the first power semiconductor switch is turned off.

7. The current-limiting switch circuit of claim 2, further comprising:
a first comparator having an input connected to the common node, the first comparator configured to drive the gates of the first power semiconductor switch and the first sense semiconductor switch; and
a second comparator having an input connected to the common node, the second comparator configured to drive the gates of the second power semiconductor switch and the second sense semiconductor switch, wherein the first power semiconductor switch, the first sense semiconductor switch, the second power semiconductor switch, and the second source semiconductor switch, the first comparator, and the second comparator are configured to limit a back current and a forward current.

8. The current-limiting switch circuit of claim 7, further comprising:
a control/monitor logic configured to sequence the first comparator and the second comparator, wherein the first power semiconductor switch is turned on before the second power semiconductor switch is turned on, and the second power semiconductor switch is turned off before the first power semiconductor switch is turned off.

9. The current-limiting switch circuit of claim 1, wherein the at least one sense semiconductor switch comprises a first sense semiconductor switch and a second sense semiconductor switch configured to share a common gate and a common drain with each other and with the first power semiconductor switch.

10. The current-limiting switch circuit of claim 9, further comprising:
a first amplifier having an input connected to the common node, the first amplifier configured to drive the gates of the first power semiconductor switch, the first sense semiconductor switch, and the second sense semiconductor switch; and
a second amplifier having an input connected to the common node, the second amplifier configured to drive the gate of the second power semiconductor switch.

11. The current-limiting switch circuit of claim 10, further comprising:
a control/monitor logic configured to sequence the first amplifier and the second amplifier, wherein the first power semiconductor switch is turned ON before the second power semiconductor switch is turned ON, and the second power semiconductor switch is turned OFF before the first power semiconductor switch is turned OFF.

12. The current-limiting switch circuit of claim 10, further comprising:
a first current source connected to the source of the first sense semiconductor switch and an input of the first amplifier to regulate the first power semiconductor switch when the sink current exceeds a predetermined current level; and
a second current source connected to a source of the second sense semiconductor switch and an input of the second amplifier wherein the second amplifier regulates the second power semiconductor switch when a reverse source current exceeds the predetermined current level.

13. A bi-directional current-limiting switch circuit, comprising:
a first power semiconductor switch;
at least a first sense semiconductor switch configured to share a common-gate and a common drain with the first power semiconductor switch, the first power semiconductor switch and the first sense semiconductor switch configured to limit at least a forward current in the current-limiting switch circuit;
a second power semiconductor switch serially connected to the first power semiconductor switch and sharing a common node therebetween; and
a second sense semiconductor switch configured to share a common-gate and a common drain with the second power semiconductor switch, the second power semiconductor switch and the second sense semiconductor switch configured to limit at least a back current in the current-limiting switch circuit.

14. The bi-directional current-limiting switch circuit of claim 13, further comprising:
a first amplifier having an input connected to the common node, the first amplifier configured to drive the gates of the first power semiconductor switch and the first sense semiconductor switch; and
a second amplifier having an input connected to the common node, the second amplifier configured to drive the gates of the second power semiconductor switch and the second source semiconductor switch, wherein the current-limiting switch circuit limits a back current and a forward current in the current-limiting switch circuit.

15. The bi-directional current-limiting switch circuit of claim 14, further comprising:
a control/monitor logic configured to sequence the second amplifier and the first amplifier to turn ON the second power semiconductor switch and first power semiconductor switch, wherein the first power semiconductor switch is turned ON before the second power semiconductor switch, and wherein the first power semiconductor switch is turned OFF before the second power semiconductor switch.

16. The bi-directional current-limiting switch circuit of claim 15, further comprising:
a first current source connected to the source of the first sense semiconductor switch and an input of the first amplifier to provide a reference voltage across the first sense semiconductor switch against which a voltage drop across the first power semiconductor switch is compared.

17. The bi-directional current-limiting switch circuit of claim 13, wherein the first and second power semiconductor switches and the first and second sense semiconductor switches are field effect transistors.

18. The bi-directional current-limiting switch circuit of claim 17, wherein the first power semiconductor switch and the second power semiconductor switch are double-diffused metal-oxide semiconductor devices.

19. A current-limiting switch circuit, comprising:
a first power semiconductor switch having a source connected to an input node of the current-limiting switch circuit;
a second power semiconductor switch having a source connected to an output node of the current-limiting switch circuit, the first power semiconductor switch serially connected to the second power semiconductor switch and sharing a common node therebetween,
a comparator having an input connected to the output node of the current-limiting switch circuit, the comparator configured to drive the gate of the first power semiconductor switch;
a control/monitor logic configured to drive the gate of the second power semiconductor switch; and
a floating power supply configured to drive the first power semiconductor switch.

20. The current-limiting switch circuit of claim 19, wherein the first power semiconductor switch and the second power semiconductor switch are field effect transistors.

21. The current-limiting switch circuit of claim 19, wherein the first power semiconductor switch and the second power semiconductor switch are double-diffused metal-oxide semiconductor devices.

22. A current-limiting switch circuit, comprising:
first power semiconductor switch having a drain connected to an input node of the current-limiting switch circuit;
at least one second power semiconductor switch having a drain connected to an output node of the current-limiting switch circuit, wherein the first power semiconductor switch and the second power semiconductor switch are serially connected between the input node and the output node of the current-limiting switch circuit;
a comparator configured to drive the gate of the second power semiconductor switch;
control/monitor logic coupled the comparator, wherein the control/monitor logic is configured to drive the gate of the first power semiconductor switch; and
a floating power supply connected to the comparator to limit the gate to source drive voltage of the second power semiconductor switch.

23. The current-limiting switch circuit of claim 22, wherein the first power semiconductor switch and the second power semiconductor switch are double-diffused metal-oxide semiconductor devices.

24. A method of operating a current-limiting switch circuit, the method comprising:
monitoring a source current:
monitoring a sink current;
comparing the source current to the sink current;
turning OFF the current-limiting switch circuit when the sink current is greater than the source current; and
turning ON the current-limiting switch circuit when the source current is greater than the sink current.

25. The method of claim 24, wherein turning OFF the current-limiting switch circuit comprises:
setting a latch causing a Q compliment to go low;
turning off a power semiconductor switch responsive to setting the latch; and
wherein turning ON the current-limiting switch circuit comprises:
resetting a latch causing the Q compliment to go high; and
turning on the power semiconductor switch responsive to resetting the latch.

26. The method of claim 24, wherein turning OFF the current-limiting switch circuit comprises:
sequencing amplifiers so that a first power semiconductor switch is OFF before a second power semiconductor switch is OFF; and
wherein turning ON the current-limiting switch circuit comprises:
sequencing the amplifiers so that the second power semiconductor switch is ON before the first power semiconductor switch is ON.

27. The method of claim 24, wherein turning OFF the current-limiting switch circuit comprises:
sequencing amplifiers so that a second power semiconductor switch is OFF before a first power semiconductor switch is OFF; and
wherein turning ON the current-limiting switch circuit comprises:
sequencing the amplifiers so that the first power semiconductor switch is ON before the second power semiconductor switch is ON.
